(19) United States
(12) Patent Application Publication
(10) Pub. No.: US 2012/0168004 A1
(43) Pub. Date: Jul. 5, 2012

(54) PAINT SPRAYING DEVICE

(75) Inventor: Alain Terrier, Le Bouscat (FR)

(73) Assignee: AIR ET PULVERISATION, LE BOUSCAT (FR)

(21) Appl. No.: 13/395,971

(22) PCT Filed: Sep. 14, 2010
(86) PCT No.: PCT/FR10/51905

§ 371 Date: Mar. 14, 2012

(30) Foreign Application Priority Data
Sep. 14, 2009 (FR) 09 56291

(51) Int. Cl. B05B 12/08

(52) U.S. Cl. 137/505

(57) ABSTRACT

A device for self-regulation and reduction of an outlet pressure (Ps), starting from an inlet pressure (Pe), designed to equip a paint spraying device, the self-regulation and reduction device including an element (28) for equalizing the output pressure at a pilot pressure (Pp) and a valve (30) that makes it possible to regulate and reduce the inlet pressure controlled by the equalizing element, so as to limit the outlet pressure by keeping the pressure essentially constant in an independent manner, the valve including a passage opening (42) more or less sealed by a sealing element (46) connected by a rod (50) to the equalizing elements (28), characterized in that the rod (50) connecting the equalizing element (28) and the sealing element (46) do not pass through the passage opening (42), the equalizing element (28) and the sealing element (46) being placed on the same side relative to the passage opening.

This invention relates to a spraying device for a paint-based product at a given so-called outlet pressure.

Generally, a known device for spraying a paint-based product comes in the form of a gun, provided with an outlet for the paint-based product outside of the spraying device at an outlet pressure and with an inlet for the paint inside the spraying device at an inlet pressure greater than the outlet pressure. The paint is injected at the inlet of the gun via a flexible hose supplied by a pressurized pump.

For an application of paint on a small surface, it is known to use high inlet and outlet pressures, on the order of 60 to 250 bar, the outlet pressure being controlled by a trigger of the gun manipulated by an operator.

However, such a device is not absolutely suitable for a more delicate application for which a high-quality finish is sought, and the paint layer obtained must be as uniform as possible. This is the case, in particular, for coating an aircraft cabin with paint.

Since the application can only be done manually and the required finish is very high, the guns used are based on the pneumatic spraying technique, sometimes with the addition of the electrostatic effect.

The use of low inlet and outlet pressures, on the order of 1 to 4 bar, is known.

However, to paint objects that are large in size or far from the pump, the flexible feed hose of the spraying device is large in diameter, on the order of 10 mm, and the length of the flexible hose can reach 5 m to 45 m. Thus, when the surface is painted, the large quantity of accumulated paint in the hose must be discharged by cleaning with a solvent. Such a known device thus presents the disadvantage that a large quantity of paint is wasted and a large quantity of solvent, often toxic, is necessary for cleaning. Moreover, the large diameter of the hose requires that an operator responsible for painting a given surface lift considerable weight, for example, on the order of about ten kilograms, posing risks of shoulder tendonitis for the operator.

In order to remedy these drawbacks, it would be possible to consider using a feed hose with a small diameter, in which the paint circulates under high pressure, and a gun that integrates a pressure reducer that makes it possible to greatly reduce the pressure at the inlet of the gun so as to obtain a low pressure at the outlet of the gun.

Document FR-2.552.345 proposes a pressure regulator that makes it possible to modulate the pressure at the inlet of the gun.

According to this document, the regulator comprises a membrane separating two chambers, including a first chamber which is supplied with pilot air, the second chamber being linked via a tube to the gun. This second chamber is supplied with paint via a valve that comprises an opening delimited by a seat on which a sealing element, attached to the membrane by a rod, can rest. According to this document, the sealing element is placed on the opposite side of the membrane relative to the opening so that the rod passes through said opening.

This type of regulating device does not make optimal pressure reduction possible.

Also, the purpose of this invention is to propose a pressure reduction device for an apparatus for spraying a paint-based product that is lightweight, of simple design, and that makes it possible to reduce pressure optimally.

For this purpose, the invention has for its object a device for self-regulation and reduction of an outlet pressure starting from an inlet pressure, intended to be installed on a paint spraying device, comprising means for equalizing the outlet pressure at a pilot pressure and a valve that makes it possible to regulate and reduce the inlet pressure controlled by said equalizing means so as to limit the outlet pressure while keeping said pressure essentially constant in an independent manner, said valve comprising a passage opening more or less sealed by a sealing element connected by a rod to the equalizing means, characterized in that the rod connecting the equalizing means and the sealing element does not pass through the passage opening, said equalizing means and the sealing element being placed on the same side relative to the passage opening.

The invention also relates to a device for spraying a paint-based product that integrates said pressure reduction device.

The invention will now be described in more detail referring to the accompanying figures provided only by way of example and in which:

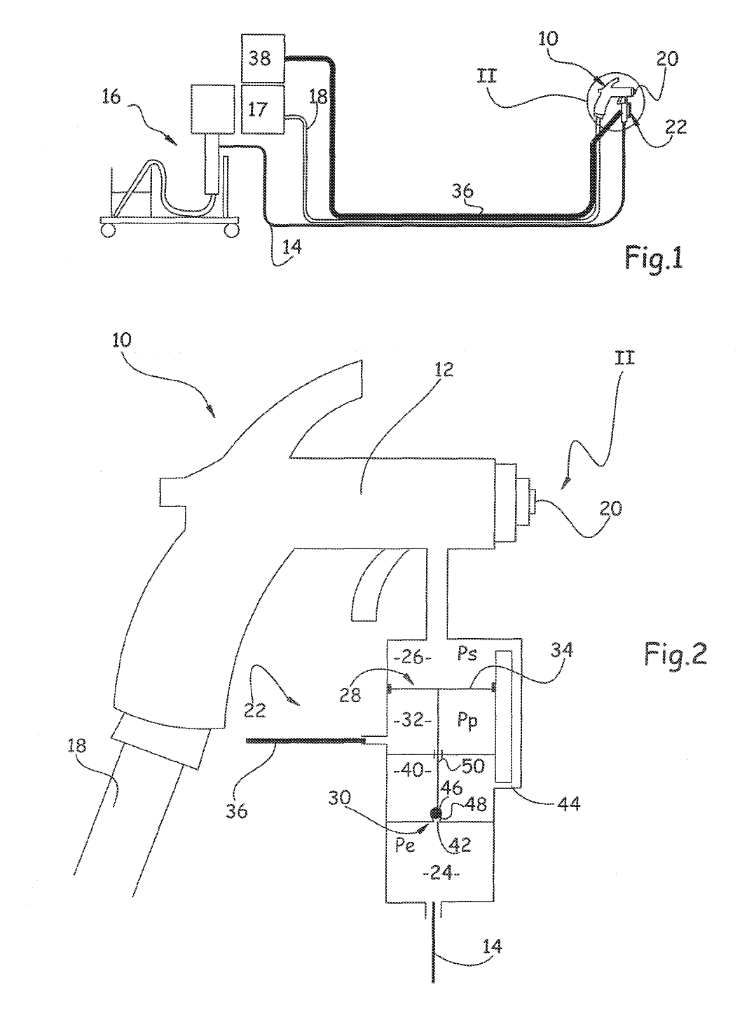

FIG. 1 is a diagrammatic representation of a spraying device according to this invention supplied with paint, atomizing air, and pilot air,

FIG. 2 is a diagrammatic representation in longitudinal cutaway of the detail II of the device of FIG. 1 according to a first variant,

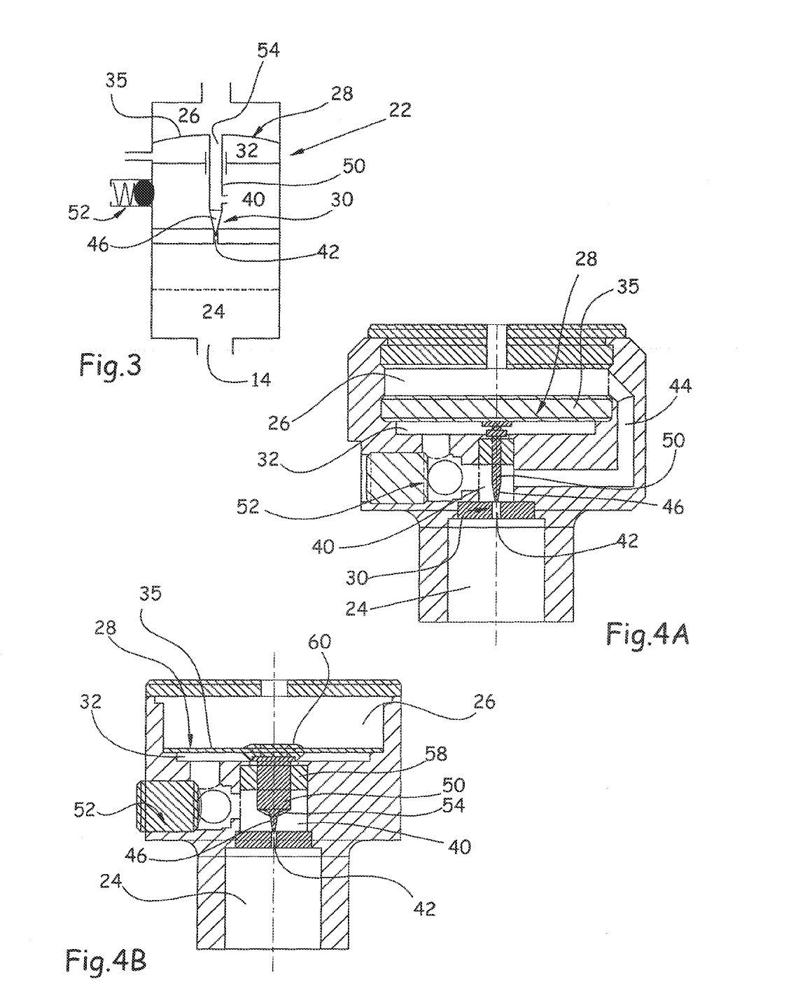

FIG. 3 is a diagrammatic representation in longitudinal cutaway of the detail II of the device of FIG. 1 according to another variant,

FIG. 4A is a cutaway of a first embodiment of the second variant,

FIG. 4B is a cutaway of a second embodiment of the second variant,

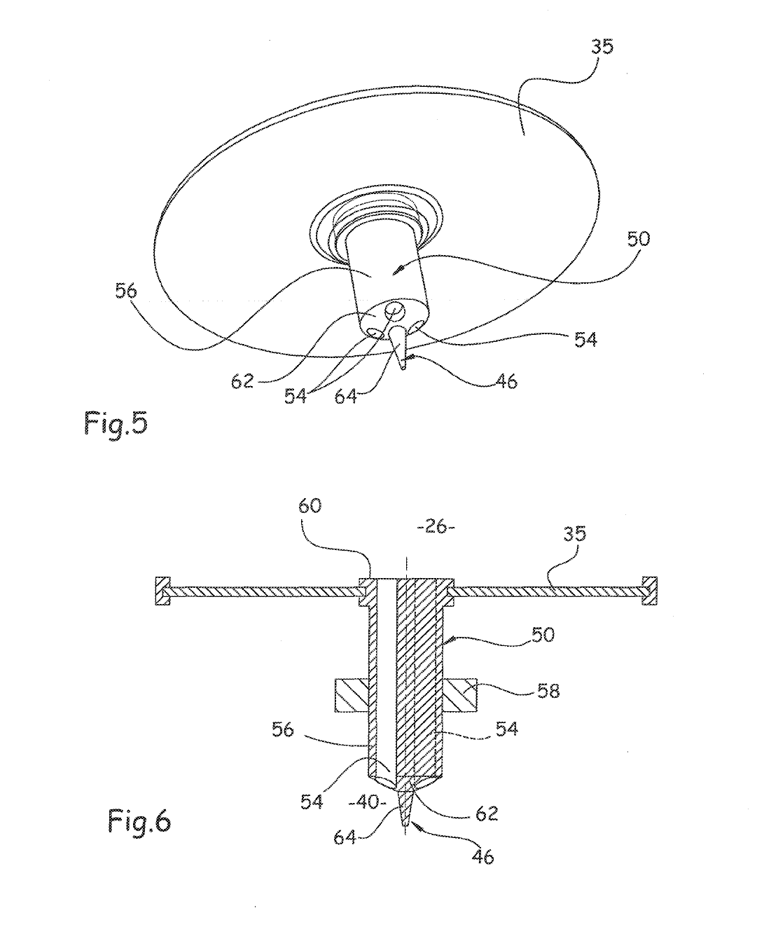

FIG. 5 is a perspective view of the sealing element of the device illustrated in FIG. 4B, and

FIG. 6 is a cutaway of the sealing element illustrated in FIG. 5.

A spraying device, referenced as 10 and designed to spray a paint-based product on a work surface at a given so-called outlet pressure, denoted Ps, is shown in FIGS. 1 and 2.

As can be seen in FIGS. 1 and 2, the device 10 comprises a spray head 12 in the form of a gun that makes the device 10 very easy to handle. The gun 12 is supplied by a flexible hose 14 supplied by a pump 16, which will not be described further because it is known to one skilled in the art. The pressure of the paint at the inlet of the device 10 is denoted Pe. The paint is mixed with compressed atomizing air that supplies the gun 12 by a pump 17 via a flexible hose 18 before being sprayed outside of the device 10 through an outlet 20. Paint-based product is defined as the paint that was mixed with atomizing air.

According to this invention, the spraying device 10 comprises a device for self-regulation and reduction 22 of the outlet pressure Ps starting from the inlet pressure Pe, the outlet pressure Ps being relatively low, whereas the inlet pressure Pe is greater than the outlet pressure Ps.

As can be seen in FIG. 2, the device 22 for self-regulation and reduction of the pressure is equipped with means 28 for equalizing the outlet pressure Ps at a pilot pressure Pp, as well as a valve 30 controlled by the equalizing means 28, so that the spraying device 10 limits the outlet pressure Ps and keeps said pressure essentially constant in an independent manner, i.e., without any outside intervention.

To give an order of magnitude, the outlet pressure Ps is advantageously between 0.3 and 4 bar, and preferentially on the order of 0.5 bar, whereas the inlet pressure Pe is advantageously between 30 bar and 300 bar.

As can be seen in FIG. 2, the device 22 for self-regulation and reduction of pressure comprises a paint inlet compartment 24 as well as a paint outlet compartment 26.

As shown in FIG. 2, the device 22 for self-regulation and reduction of pressure also comprises a pilot compartment 32 that can be filled with pilot fluid at the pilot pressure Pp, the pilot compartment 32 being separated from the outlet compartment 26 by the equalizing means 28.

According to a variant illustrated in FIG. 2, the equalizing means 28 come in the form of a piston 34 that can move in a direction of reducing the volume of the pilot compartment 32 when the outlet pressure Ps is greater than the pilot pressure Pp and in a direction of increasing the volume of the pilot compartment 32 when the outlet pressure Ps is less than the pilot pressure Pp.

In FIG. 2, the direction of increasing the volume of the pilot compartment 32 corresponds to an upward displacement of the piston 34, whereas the direction of reducing the volume of the pilot compartment 32 corresponds to a downward displacement of the piston 34.

According to another variant illustrated in FIGS. 3, 4A, 4B, 5 and 6, the equalizing means 28 come in the form of a membrane 35 in the shape of a disk the periphery of which is stationary relative to the wall that delimits compartments 26 and 32 and the central portion of which can deform in a direction of reducing the volume of the pilot compartment 32 when the outlet pressure Ps is greater than the pilot pressure Pp and in a direction of increasing the volume of the pilot compartment 32 when the outlet pressure Ps is less than the pilot pressure Pp.

In FIG. 3, the direction of increasing the volume of the pilot compartment 32 corresponds to an upward displacement of the central portion of the membrane 35, whereas the direction of reducing the volume of the pilot compartment 32 corresponds to a downward displacement of the central portion of the membrane 35.

In the case of painting, the membrane is preferred, since the piston has a tendency to “stick” to the walls of the compartments 26 and 32 when the paint has dried.

Advantageously, the pilot fluid is compressed air introduced into the pilot compartment 32 via a flexible hose 36 in which the air circulates from a pump 38 that constitutes means to supply the device 10 with pilot fluid. The flexible hose 36 for supplying pilot air has an outside diameter on the order of 4 mm.

It is possible to use a hose 18 with a small diameter if a high pressure Pe is used.

The means 22 for reducing pressure comprise an intermediate compartment 40 for paint circulation from the inlet compartment 24 to the outlet compartment 26. This intermediate compartment 40 is adjacent to the inlet compartment 24 and comprises a paint inlet 42—also called a passage opening—that links the inlet compartment 24 and the intermediate compartment 40, as well as a tube 44 connecting the intermediate compartment 40 and the outlet compartment 26.

The valve 30 comprises a sealing element 46 of the inlet 42 of the intermediate compartment 40, as well as a seat 48 that borders the inlet 42 of the intermediate compartment 40. The sealing element 46 can move between a complete sealing position of the inlet 42 in which it is in contact with the seat 48 and open positions of the inlet 42 in which it is no longer in contact with the seat 48, the gap between the sealing element 46 and the seat 48 making it possible to control the flow of paint entering the intermediate compartment 40. Advantageously, the displacement of the sealing element 46 is continuous, so that the quantity of paint entering the intermediate compartment 40 is continuously modulated by the gradual displacement of the sealing element 46 between the completely sealed position of the inlet 42 and the completely open position of the inlet 42.

The displacement of the sealing element 46 is controlled by the displacement of the equalizing means 28, a rod 50 connecting the equalizing means to the sealing element 46.

Thus, a displacement of the equalizing means 28 in the direction of reducing the volume of the outlet compartment 26, i.e., upwards in FIG. 2, involves an upward translational movement of the rod 50, and a displacement of the sealing element 46 towards the open position of the inlet 42.

In the opposite direction, a displacement of the equalizing means 28 in the direction of increasing the volume of the outlet compartment 26, i.e., downward in FIG. 2, involves a downward translational movement of the rod 50, and a displacement of the sealing element 46 towards the position of partial or even complete sealing of the inlet 42.

Advantageously, the compartment 40 comprises a safety valve 52 that is triggered when the internal pressure of the compartment 40 surpasses a certain threshold. This arrangement makes it possible to guarantee that the outlet pressure Ps entering the gun 12 is less than the maximum pressure permissible for said gun so as not to inject paint into the gun at a pressure higher than that recommended by the gun manufacturer so as not to damage it.

The operation of the device 10 that is already evident from the preceding description will now be described in detail.

When an operator wants to coat a work surface with paint, he grips the spraying device 10 in the form of a gun and activates the paint supply of the device 10 by means of the high-pressure pump 16, the paint mixed with compressed air circulating in the flexible hose 18.

When the outlet flow increases, the outlet pressure Ps decreases and becomes less than the pilot pressure, which causes an upward displacement of the equalizing means 28 and a gradual opening of the inlet 42 of the intermediate compartment 40. Thus, an additional quantity of paint enters the outlet compartment 26, which increases the pressure exerted by the paint on the equalizing means 28, until the Ps and Pp pressures are equalized. Then, the Ps pressure becomes stabilized at the pilot value.

In contrast, when the outlet flow decreases, the outlet pressure Ps increases until it becomes greater than the pilot pressure Pp, causing the downward displacement of the equalizing means 28 and a gradual closing of the inlet 42 of the intermediate compartment 40. Thus, the supply of paint to the outlet compartment 26 is reduced, which reduces the pressure exerted by the paint on the equalizing means 28 until the Ps and Pp pressures are equalized, at which point the Ps pressure becomes stabilized at the pilot value.

Thus, any variation of the outlet pressure Ps is automatically “absorbed” by the device 10, the device 10 ensuring the self-regulation of the outlet pressure Ps. This self-regulation makes it possible to obtain better pressure constancy and thereby to limit paint running.

Unlike the prior art, which specifies that the gun, which operates with a paint at low pressure (on the order of 2 bar), is supplied with paint at low pressure circulating in a hose of large cross-section, the invention proposes supplying the gun that operates with a paint at low pressure (on the order of 0.3 to 4 bar, preferably on the order of 0.5 bar) with the paint circulating in a hose 18 of reduced cross-section, the paint being subjected to high pressure (capable of attaining 300 bar) to ensure an adequate flow given the reduced cross-section of the hose 18 and a pressure reducer being provided at the inlet of the gun. To obtain adequate pressure in the hose 18, the latter is supplied in paint by a so-called high pressure pump 17 that can deliver a mixture of paint and compressed air at a pressure that can reach 300 bar.

The following table is a comparison of the characteristics of a device with a low pressure supply pump of the prior art and the device 10 for a special application. In this example, a pump supplies six guns, therefore six flexible hoses 14, each 25 m in length.

| | Spraying Device | Device |
|---|---|---|
| | According to | of the |
| Description | this Invention | Prior Art |
| Total Length of Flexible | 150 m | 150 m |
| Hoses (for 6 Hoses) | | |
| Internal Diameter of | 3.2 mm | 9.7 mm |
| Flexible Hose | | |
| Volume of Paint Wasted | 1.2 L | 11.4 L |
| Weight of Flexible Hose | 4.2 kg | 11.8 kg |
| Filled with Paint | | |
| Volume of Solvent | 8 L | 40 L |
| Necessary For Cleaning | | |
| Duration of Cleaning | 7 min | 20 min |

As can be seen in the preceding table, the spraying device 10 makes it possible, with an equal length of flexible hose 14, for the flexible hose 14 to be 3 times smaller in diameter, which makes it possible for the paint contained in the flexible hose 14 to be approximately 2.8 times lighter in weight and 5 times smaller in volume of solvent necessary for cleaning the flexible hose 14. Incidentally, the duration of cleaning is also considerably reduced.

Thus, thanks to the spraying device according to this invention, the weight of the flexible hose that an operator must handle is considerably reduced, which limits the risks of shoulder tendonitis common with the use of low-pressure spraying devices of the prior art. Moreover, the diameter of the flexible hose being smaller, the quantity of paint lost decreases, as does the quantity of cleaning solvent.

Thanks to the small diameters of the flexible hoses 14 for paint, pilot fluid 36 [sic], and compressed air 18 for atomization, it is possible to make the three hoses 14, 16, and 18 integral, for example by thermobonding, which makes the device 10 easier to use.

The invention also relates to an installation for spraying a paint-based product, including means for supplying paint to the installation, such as a pump, as well as a spraying device such as previously described. The pump according to the invention has a particular structure to the extent that it has a long stroke, small circular surfaces, as well as precise adjustment of the piston stroke. This structure reduces the retention volume and makes cleaning easier.

The pressure reduction device, according to this invention, can be adapted to ordinary pneumatic or electrostatic paint guns, does not entail a modification of application procedure or change the painter's body movements. According to the invention, the rod 50 connecting the equalization means 28 and the sealing element 46 do not pass through the inlet 42. Thus, in contrast to the prior art where the sealing element is placed on the opposite side of the equalization means relative to the inlet 42, according to the invention, the equalization means 28 and the sealing element 46 are placed on the same side relative to the inlet 42. In this way, the inlet passage cross-section 42 is not ring-shaped, but disk-shaped, according to the invention. This configuration makes it possible to obtain a surface for the smallest inlet passage cross-section 42 while making possible the passage of solid elements in the paint, such as larger feedstocks.

This configuration makes it possible to optimize pressure reduction by reducing the ratio between the surface of the inlet passage cross-section 42 and the surface of the equalizing means cross-section 28 without increasing the equalizing means cross-section so as to obtain the lightest and least bulky device possible.

By way of example, it is possible to anticipate a ratio of 1/2000 with a cross-section at the inlet on the order of 0.19 mm² (i.e., a diameter on the order of 0.5 mm) and a cross-section at the membrane on the order of 415 mm² (i.e., a diameter on the order of 23 mm). Since the inlet 42 is not encumbered by a rod that ensures the connection between the membrane and the sealing element 46, the reduction ratio is optimized to the extent that, at equal spacing between the walls, a circular cross-section provides a smaller surface than a ring-shaped cross-section.

To reduce the dimensions of the pressure reduction device, the rod 50 comprises at least one tube 54 to link the intermediate compartment 40 with the outlet compartment 26 as illustrated in FIGS. 3, 4B, 5 and 6. Thus, it is possible to eliminate the tube 44 that tends to increase the cross-section of the pressure reduction device.

According to an embodiment illustrated in FIGS. 4B, 5 and 6, the rod 50 and the sealing element 46 are integral and comprise a cylindrical portion 56 that can slide into a sheath 58 separating compartments 32 and 40 having, at a first end 60, means for making the equalizing means 28 integral so that said end 60 is placed in the outlet compartment 26, and having, at the other end, a tapered truncated shape 62 followed by a sharpened conical shape 64 that ensures the function of the sealing element 46. Preferably, at least one tube 54 extends over the entire height of the cylindrical portion 56 and comes out, on the one hand, at the end 60 and, on the other hand, at the tapered truncated shape 62. Advantageously, three tubes 54 placed at 120° are provided.

As a variant, it would be possible to consider a hollow cylindrical portion 56 that comes out at the end 60 and having, at its lower part, openings that make it possible to link the inside of the hollow, cylindrical portion 56 with the intermediate compartment 40.

1. Device for self-regulation and reduction of an outlet pressure (Ps) starting from an inlet pressure (Pe), designed to equip a paint spraying device, said self-regulation and reduction device comprising means (28) for equalizing the outlet pressure (Ps) at a pilot pressure (Pp) and a valve (30) that makes it possible to regulate and reduce the inlet pressure (Pe) controlled by said equalizing means (28), so as to limit the outlet pressure (Ps) by keeping said pressure essentially constant in an independent manner, said valve (30) comprising a passage opening (42) more or less sealed by a sealing element (46) connected by a rod (50) to the equalizing means (28), characterized in that the rod (50) that connects the equalizing means (28) and the sealing element (46) do not pass through the passage opening (42), said equalizing means (28) and the sealing element (46) being placed on the same side relative to the passage opening (42).

2. Pressure self-regulation and reduction device according to claim 1, wherein it comprises a paint outlet compartment (26) and a pilot compartment (32) that can be filled with pilot fluid at the pilot pressure (Pp), the equalizing means (28) being able to move in a direction of reducing the volume of the pilot compartment (32) when the outlet pressure (Ps) is greater than the pilot pressure (Pp) and in a direction of increasing the volume of the pilot compartment (32) when the outlet pressure (Ps) is less than the pilot pressure (Pp).

3. Pressure self-regulation and reduction device according to claim 2, wherein it comprises an inlet compartment (24) and an intermediate compartment (40) for the circulation of paint from the inlet compartment (24) up to the outlet compartment (26), the valve (30) being placed between the intermediate compartments (40) and the inlet compartment (24).

4. Pressure self-regulation and reduction device according to claim 1, wherein the equalizing means (28) come in the form of a membrane (35).

5. Pressure self-regulation and reduction device according to claim 3, wherein the rod (50) comprises at least one tube (54) for linking the intermediate compartment (40) with the outlet compartment (26).

6. Pressure self-regulation and reduction device according to claim 5, wherein the rod (50) and the sealing element (46) are produced in a single piece and comprise a cylindrical portion (56) having, at a first end (60), means for attaching the equalizing means (28) so that said end (60) is placed in the outlet compartment (26), and having, at the other end, a tapered truncated shape (62) followed by a sharpened conical shape (64) that ensures the function of the sealing element (46).

7. Device for spraying a paint-based product that comprises a pressure self-regulation and reduction device according to claim 1, said spraying device being equipped with an outlet (20) of said paint-based product outside of the spraying device (10) at an outlet pressure (Ps) and with a paint inlet (12) in the device (10) at an inlet pressure (Pe) greater than the outlet pressure (Ps), said spraying device (10) comprising means (28) for equalizing the outlet pressure (Ps) at a pilot pressure (Pp) and a valve (30) that makes it possible to regulate and reduce the inlet pressure (Pe) controlled by said equalizing means (28) so as to limit the outlet pressure (Ps) by keeping said pressure essentially constant in an independent manner, said valve (30) comprising a passage opening (42) more or less sealed by a sealing element (46) connected by a rod (50) to the equalizing means (28), wherein the rod (50) connecting the equalizing means (28) and the sealing element (46) do not pass through the passage opening (42), said equalizing means (28) and the sealing element (46) being placed on the same side relative to the passage opening (42).

8. Device for spraying a paint-based product according to claim 7, wherein the outlet pressure (Ps) is between 0.3 bar and 4 bar.

9. Device for spraying a paint-based product according to claim 7, wherein the inlet pressure (Pe) is between 30 bar and 300 bar.

10. Installation for spraying a paint-based product that comprises means for supplying the installation in paint, wherein it comprises a spraying device according to claim 7.

11. Pressure self-regulation and reduction device according to claim 2, wherein the equalizing means (28) come in the form of a membrane (35).

12. Pressure self-regulation and reduction device according to claim 4, wherein the rod (50) comprises at least one tube (54) for linking the intermediate compartment (40) with the outlet compartment (26).

13. Pressure self-regulation and reduction device according to claim 12, wherein the rod (50) and the sealing element (46) are produced in a single piece and comprise a cylindrical portion (56) having, at a first end (60), means for attaching the equalizing means (28) so that said end (60) is placed in the outlet compartment (26), and having, at the other end, a tapered truncated shape (62) followed by a sharpened conical shape (64) that ensures the function of the sealing element (46).

14. Device for spraying a paint-based product according to claim 8, wherein the inlet pressure (Pe) is between 30 bar and 300 bar.
